(19) United States
(12) Patent Application Publication
(10) Pub. No.: US 2021/0362132 A1
(43) Pub. Date: Nov. 25, 2021

(54) METAL OXIDE CATALYSTS FOR REMOVAL OF LARGE CAPACITY PERFLUORINATED COMPOUNDS

(71) Applicants: Coretech Co., Ltd., Anseong-si (KR); Samsung Electronics Co., Ltd., Suwon-Si (KR)

(72) Inventors: Young Hwan Moon, Anseong-si (KR); Jong San Kim, Anseong-si (KR); Heon Jung, Cheonan-si (KR); Eun Seo Park, Cheonan-si (KR); Deung Ki Yun, Suwon-si (KR); Sun Choi, Hwaseong-si (KR); Seung Youn Jung, Hwaseong-si (KR); Jun Min Yeom, Anseong-si (KR)

(21) Appl. No.: 17/398,150

(22) Filed: Aug. 10, 2021

Related U.S. Application Data
(62) Division of application No. 16/597,927, filed on Oct. 10, 2019, now abandoned.

(30) Foreign Application Priority Data
Jan. 10, 2019 (KR) 10-2019-0003434

(51) Int. Cl. B01J 23/755; B01J 23/30; B01J 6/00; B01J 37/02; B01J 37/03; B01J 37/04

(52) U.S. Cl. CPC B01J 23/755; B01J 23/30; B01J 37/04; B01J 37/0201; B01J 37/03; B01J 6/001

(57) ABSTRACT

A catalyst for decomposing perfluorinated compounds is composed of tungsten (W) compound and nickel (Ni) compound as main components and composed of aluminum (Al) compound or silicon (Si) compound as a supporter.

### CROSS REFERENCE TO RELATED APPLICATIONS

This application is a division of U.S. patent application Ser. No. 16/597,927, filed on Oct. 10, 2019, which claims priority to Korean Patent Application No. 10-2019-0003434, filed on Jan. 10, 2019, which is hereby incorporated by reference in its entirety into this application.

### BACKGROUND OF THE INVENTION

### 1. Field of the Invention

A present invention relates to the acid resistant catalysts capable of decomposing perfluorinated compounds, a producing method thereof and the use thereof. More specifically, the present invention relates to a catalyst for decomposing perfluorinated compounds, comprising a supporter composed of at least one or more selected from alpha alumina, gamma alumina, pseudo-boehmite and silicon and an aluminum compounds support prepared by mixing, drying and calcining tungsten (W) and nickel (Ni) compounds in a water-containing solvent. Preferably, the present invention relates to an aluminum, tungsten and nickel compounds mixed catalyst for decomposing perfluorinated compounds, in which tungsten (W) and nickel (Ni) compounds are impregnated as an active component using a neutral precipitation method.

### 2. Description of Related Art

Hazardous waste gases are emitted in different types based on each process in a wide variety of semiconductor manufacturing processes. Most of these gases are highly volatile and highly global warming potential. These gases are harmful to a human body and hence, PFC (perfluorocompound) removal is required.

Among them, perfluorocompound (PFC), which is a perfluorinated compound mainly discharged from the etching and deposition (CVD) processes in the semiconductor manufacturing process, is very stable and not easy to remove.

PFCs are stabler than CFCs (chlorofluorocompound) used as refrigerants, and have a large global warming index and a long decomposition time, which causes a problem that they are accumulated in the atmosphere when released.

The more PFCs is emitted at a higher rate from semiconductor manufacturing processes each year, the more impacts on global warming. Accordingly, the regulation on the PFCs is gradually tightened.

There have been attempts to develop new alternative gases to reduce PFC emissions, however, no alternative gases more efficient and productive than CF₄, have been presented as a gas used for etching silicon substrate in the semiconductor manufacturing process. As a result, CF₄ is in use in most semiconductor manufacturing processes.

A number of technologies are under development to eliminate PFCs, especially the carbon-based PFCs. These technologies could be divided into separate recovery areas and deconstruction areas, the former using PSA and separation film, the latter using plasma, combustion, or catalysts.

Catalytic decomposition is the technology of dissolving PFC at low temperatures not more than 800° C. with catalysts and water vapor. The catalytic methods dramatically reduce the temperature of decomposition, which brings about many advantages.

For example, when PFC is decomposed at the temperature of 800° C. or lower, it is easy to reduce operating costs and to ensure the durability of the system due to the continuous operation. It has also the advantage of inhibiting the occurrence of thermal NOx with the presence of N₂ in exhaust gases, greatly reducing the device corrosion. Furthermore, the size of the scrubber can be greatly reduced and miniaturized by increasing the reaction activity of the catalyst.

However, catalytic decomposition has a problem in that the catalysts need to be periodically replaced because halogen compounds such as HF and F₂ generated after the reaction rapidly degrade the performance of the catalyst. In order to solve this problem, various attempts have been made to return the catalyst to its original state, such as bringing it into contact with water vapor or forming a film on the surface of the catalyst.

In Japanese Patent Laid-Open Nos. 11-70332 and 10-46824, a catalyst to decompose perfluorinated compounds is disclosed in the form of a complex oxide of aluminum and a metal component including at least one of various transition metals such as Zn, Ni, Ti, Fe, etc. in an aluminum oxide and U.S. Pat. Nos. 6,023,007 and 6,162,957 disclose that various kinds of metal phosphate catalysts can be used as catalysts for decomposing perfluorinated compounds.

However, aluminum phosphate in the form of a poly-component compound oxide, in which a metal component is added as described above is not only complicated in manufacturing process but also disadvantageous in terms of economy and its durability. Hence, there is still a need for a simple and economical method for producing a catalyst having a durability that can be maintained for a long time.

### SUMMARY

The purpose of present invention is to provide a catalyst capable of completely decomposing a perfluorinated compound containing a halogen compound, which is an acidic gas emitted as a byproduct after being used in a semiconductor manufacturing process or a display manufacturing process, such as an LCD. It is an object of present invention to provide a catalyst that maintains catalyst activity for a long time with excellent durability.

A solution to solve the problem is to provide a catalyst for decomposing perfluorinated compounds, comprising tungsten (W) and nickel (Ni) compounds as main components and composed of aluminum (Al) or silicon (Si) compounds as a support material.

Another solution to solve the problem is to provide a catalyst for decomposing perfluorinated compounds, in which a tungsten (W) compound is sodium tungstate (Na₂WO₄.2H₂O), ammonium paratungstate (5(NH₄)₂O.12WO₃.5H₂O), tungsten oxide (WO₃), tungsten chloride (WCl₆) or mixtures thereof, a nickel (Ni) compound is nickel nitrate (Ni(NO₃)₂.6H₂O), nickel sulfate (NiSO₄.6H₂O), nickel hydro oxide (Ni(OH)₂, nickel oxide (NiO) or mixtures thereof, at least one from alpha alumina, gamma alumina and pseudo-boehmite is selected as an aluminum (Al) compound and either silica (SiO₂) or water glass is selected as a silicon (Si) compound.

Another solution to solve the problem is to provide a catalyst for decomposing perfluorinated compounds, comprising a catalyst support prepared by mixing in a solvent, drying, and calcining a raw material with the weight ratio of Al:W:Ni compounds (mass)=100:0.1˜10:0.1˜50.

Another solution to solve the problem is to provide a catalyst for decomposition and removal of perfluorinated compounds, prepared using Sol-Gel, neutral precipitation, impregnation, and co-precipitation as a method of preparing the catalyst.

Another solution to solve the problem is to provide a catalyst for decomposing a perfluorinated compounds, prepared using Sol-Gel, neutral precipitation, impregnation, and co-precipitation as a method of preparing the catalyst.

Another solution to solve the problem is to provide a catalyst for decomposing perfluorinated compounds, prepared by selecting one from a basic solution group composed of ammonia water, caustic soda water, and quicklime water as a neutralizing agent.

Furthermore, another way is to provide a catalyst for decomposing a perfluorinated compounds, prepared by selecting one from an acidic solution group composed of sulfuric acid, hydrochloric acid, nitric acid and acetic acid as a dispersant of raw metal materials.

Another solution to solve the problem includes steps of; mixing tungsten (W) and nickel (Ni) compounds as main components and mixing aluminum (Al) or silicon (Si) compounds as a supporter; shaping the mixed compounds into one or more form from particles, spheres, pellets and rings; and drying and calcining the shaped catalyst to prepare a catalyst for decomposing perfluorinated compounds.

### Advantageous Effects

The catalyst for decomposing the perfluorinated compound according to the present invention is an acid resistant catalyst and has the effect of enhancing a durability against fluorine generated by decomposition of a halogen acidic gas contained in the perfluorinated compound or a perfluorinated compound and enhancing reaction activity.

The catalyst for decomposing the perfluorinated compound according to the present invention can be used for the purpose of decomposing the perfluorinated compound in cleaning agent and etchant used in the semiconductor manufacturing process and the display manufacturing process and particularly, it has an advantageous effect in the process of decomposing the perfluorinated compound discharged from the process in which halogen acid gas such as F₂, Cl₂, Br₂, etc. is used.

### BRIEF DESCRIPTION OF DRAWINGS

FIG. 1 shows the crystal phase change of the catalyst before and after CF₄ decomposition using the Al oxide catalyst of Example 1.

FIG. 2 shows the crystal phase change of the catalyst before and after CF₄ decomposition using the Ni—Al oxide catalyst of Example 5.

### DETAILED DESCRIPTION OF THE INVENTION

The first embodiment of the present invention provides a catalyst for decomposing perfluorinated compounds, comprising aluminum, tungsten and nickel compounds mixed supports prepared with the weight ratio of Al:W:Ni compounds (mass)=100:0.1˜10:0.1˜50. by neutralization precipitation, drying, and calcining in a water-solvent to which a pseudo-boehmite raw material and aluminum, tungsten and nickel compounds are added.

The second embodiment of the present invention provides a catalyst for decomposing perfluorinated compounds, comprising steps of; mixing aqueous solution of tungsten and nickel compounds with an aluminum compound selected from the group of alpha alumina, gamma alumina, and pseudo-boehmite (step 1); and preparing Al—W—Ni oxide with the weight ratio of Al:W:Ni compounds (mass)=100:0.1˜10:0.1˜50 by drying and calcining (step 2).

A third embodiment of the present invention provides a method for treating perfluorinated compounds, comprising the steps of decomposing the perfluorinated compounds in perfluorinated compound-containing gas using the catalyst for decomposing perfluorinated compounds of the first embodiment of the present invention.

The fourth embodiment of the present invention provides a semiconductor manufacturing process or a display manufacturing process, comprising the steps of decomposing a perfluorinated compounds in perfluorinated compound-containing gas using the catalyst for decomposing perfluorinated compounds of the first embodiment of the present invention.

“Perfluoro compounds (PFCs)” include carbon-containing perfluoro compounds (PFCs) containing two or more fluorine (F), nitrogen-containing perfluoro compounds (PFCs), and sulfur-containing perfluoro compounds (PFCs).

Carbon-containing PFCs include cyclic aliphatic and aromatic perfluorocarbons as well as saturated and unsaturated aliphatic components, such as CF₄, CHF₃, CH₂F₂, C₂F₄, C₂F₆, C₃F₆, C₃F₈, C₄F₈, and C₄F₁₀.

The nitrogen-containing PFCs typically include NF₃ and a sulfur-containing PFC includes SF₄, SF₆ and so on.

However, in the present specification, perfluorinated compounds (PFCs) can be extended to the compounds capable of being decomposed by a catalyst to form a gaseous product such as HF, which is also within the scope of the present invention.

A tungsten (W) compound in the present invention is sodium tungstate (Na₂WO₄.2H₂O), ammonium paratungstate (5(NH₄)₂O.12WO₃.5H₂O), tungsten oxide (WO₃), tungsten chloride (WCl₆) or mixtures thereof, a nickel (Ni) compound in the present invention is nickel nitrate (Ni(NO₃)₂.6H₂O), nickel sulfate (NiSO₄.6H₂O), nickel hydroxide (Ni(OH)₂), nickel oxide (NiO), or mixtures thereof and a catalyst for decomposing perfluorinated compounds is prepared by selecting at least one from alpha alumina, gamma alumina, pseudo-boehmite as an aluminum (Al) compound and by selecting either silica or water glass (SiO₂) as a silicon (Si) compound.

Acid gases become acidic when they come in contact with water and non-limiting examples thereof include halogen, hydrogen halide, nitrogen oxides (NOx), sulfur oxides (SOx), acetic acid, mercury sulfide, hydrogen sulfide, and carbon dioxide. Acid gases not only cause corrosion, but also lower the activity of the catalyst.

The hydrolysis reaction between PFC and water is an endothermic reaction, thus the decomposition of PFC proceeds more rapidly at a higher temperature because high temperature can induce spontaneous reaction, which makes it easier to decompose. However, high temperatures lower the thermal stability of the catalyst.

In other words, operating conditions of 500˜800° C. is a high temperature condition for the catalyst to maintain the activity for a long time without physical or chemical changes, which is the biggest obstacle to ensuring the durability of the catalyst. In particular, it is the key to commercialization to develop a catalyst having a lasting durability under the reaction atmosphere of 500˜800° C. where HF and water vapor generated as by-products at the same time.

In order to increase the resistance to halogen acid gas, highly dispersing the active component is preferable, but high dispersion techniques of the active component are not easy, thus there is a problem that the decomposition activity is lowered.

Therefore, in order to solve this problem one embodiment of a catalyst for decomposing perfluorinated compounds according to the present invention is to prepare a porous catalyst support in which tungsten and nickel active metal compounds are co-precipitated in aluminum compound so that aluminum, tungsten, and nickel compounds can be uniformly mixed with the ratio of Al:W:Ni compounds (mass)=100:0.1˜10:0.1˜50.

Another embodiment of the catalyst for decomposing perfluorinated compounds according to the present invention is to prepare aluminum, tungsten and nickel compounds mixed catalyst support in which pseudo-boehmite raw material is mixed with the tungsten (W) and nickel (Ni) compounds in a solvent, dried and calcined with a weight ratio of Al:W:Ni compounds=100:0.1˜10:0.1˜50.

Most catalysts applicable in the catalytic decomposition of perfluorinated compounds are solid acid catalysts. Among these, Al₂O₃ catalyst is the most used.

Therefore, in the catalyst for decomposing perfluorinated compounds according to the present invention, aluminum compound serves not only as a support that is supported on an active metal but also as a main catalyst having a perfluorinated compound decomposition activity. In terms of catalytic activity, γ-alumina is preferred among α, γ, δ-alumina. In addition, if the transition of γ-alumina to the a phase can be suppressed, high resolution to PFC can be maintained for a long time.

When tungsten (W) compound is impregnated as the active metal, it is possible to improve the catalyst efficiency for HF generated during PFC decomposition catalysis.

Said active metal may be impregnated on the catalyst support by an incipient-wetness method.

In steps 2 and 3, drying and calcination can be carried out independently; primary drying in a constant temperature and humidity of 110° C.; secondary drying at 200° C. or higher and tertiary drying under the air atmosphere of 400-1000° C.

The final shape of a catalyst for decomposing perfluorinated compounds according to the present invention is granular shape such as spheres, pellets, or rings, or be shaped into a honeycomb shape or the like. As for a catalyst shaping method, an extrusion molding method, a tableting molding method, and a rolling granulation method can be used. It is also possible to coat the catalyst of the present invention on a honeycomb or plate made of ceramic or metal.

As the catalyst for decomposing perfluorinated compounds according to the present invention shows excellent decomposition effect and durability in decomposing and removing perfluorinated compounds containing halogenated acidic gas, it can be used in the process containing halogenated acidic gas, particularly for the purpose of decomposing perfluorinated compounds in cleaning agents, etchants and solvents used in the semiconductor manufacturing industry and LCD processes. Furthermore, it has more advantageous effect on the decomposition and removal of the perfluorinated compounds released from the process using halogen acids such as F₂, Cl₂, Br₂, etc. It has a beneficial effect on decomposition and removal of the perfluorinated compounds.

As the catalyst that decomposes CF₄ can decompose most of the PFC contained in the waste gas and can convert carbon forming the perfluorinated compound into CO₂, it can be mainly used to treat waste gas generated in the semiconductor manufacturing process. But PFCs can also be usefully used in the process or workshop where the PFC is used or manufacture for cleaning agents, etchants, solvents, reaction raw materials, and the like.

Acid gases, including hydrofluoric acid (HF), are removed through an acid gas scrubber and then discharged. However, hydrofluoric acid generated from hydrolysis not only causes serious corrosion problems in post-stage processes including RCS but also affects the activity of PFC decomposition catalysts.

As the catalyst for decomposition of perfluorinated compounds according to the present invention is durable in halogen acid gas, it is particularly suitable for treating perfluorinated compound-containing gas containing halogen acid gas and has an increased effect compared with the prior art.

In the present invention, the temperature during the catalytic decomposition of PFC is 500 to 800° C., preferably 600 to 750° C., more preferably 500 to 600° C.

The catalyst according to the present invention can be used as it is prepared as a particle or in the form of spheres, pellets, rings, and the like with required size to decompose and remove the perfluorinated compound in the waste gas and then used a bed in the catalyst reactor. The catalyst layer formed inside the catalytic reactor may be operated in the form of a packed bed (or fixed bed) or a fluidized bed.

Water is introduced into the reactor from the outside in order to perform the hydrolysis reaction in the catalytic reactor. Water is supplied through a separate source provided outside the reactor, and is heated to be in the form of water vapor through a heat exchanger before being introduced into the reactor. Preferably, the water supplied into the reactor is pure water, and the amount of water to be supplied is adjusted in consideration of the hydrolysis reaction rate.

The water vapor includes a molar ratio of water vapor/PFC in the range of 1 to 100, and oxygen is used in a concentration range of 0 to 50% with water vapor to decompose PFC without the deactivation of the catalyst. Reaction activity will fall when content of water vapor is out of the said range.

Preparation of a catalyst for decomposing perfluorinated compounds according to the present invention is prepared by selecting one of the sol-gel (Sol-Gel) method, neutralization precipitation method, impregnation method and co-precipitation method.

The neutralizing agent used in the preparation of the catalyst for decomposing the perfluorinated compounds according to the present invention uses one or more of ammonia water, caustic soda water and quick lime water.

The dispersant for the metal raw materials used in the preparation of the catalyst for decomposition of perfluorinated compounds according to the present invention is used by selecting one from sulfuric acid, hydrochloric acid, nitric acid and acetic acid.

The protection scope of the present invention includes a method for producing a catalyst for decomposition of perfluorinated compounds according to the present invention.

The method for preparing a perfluorinated compound decomposition catalyst includes tungsten (W) and nickel (Ni) compounds as main components, comprising steps of; mixing tungsten (W) and nickel (Ni) compounds; and shaping the mixed compound in the form of particles, spheres, pellets and rings.

The present invention includes steps of; drying the catalyst for decomposition of the molded perfluorinated compounds; and calcining the dried catalyst.

The method for producing a perfluorinated compounds decomposition catalyst according to the present invention includes a configuration related to the production method among the technical configurations applied in the catalyst for decomposing the perfluorinated compounds described above.

While including the composition of the regular embodiment of the present invention and within the range of numerical values given, a catalyst was prepared by applying a specific value and the effect of the prepared catalyst was investigated.

### [Example 1] Preparation of Ni—Al Oxide Catalyst

100 g of water-boehmite was added to 500 g of distilled water and then 10 g of nitric acid was added and completely dissolved. Nickel oxide was added to the dissolved liquid mixture and stirred for 6 hours. The mixed solution was neutralized to pH 8 with ammonia water. After filtration, the mixture was dried at 110° C. for 6 hours and calcined at 750° C. for 4 hours to prepare Ni—Al oxide. The amount of nickel oxide was applied to the ratio of 20% to the weight of Al of boehmite.

### [Example 2] Preparation of Ni—Al Oxide Catalyst

Ni—Al oxide was prepared in the same manner as in Example 1 except that the amount of nickel oxide was 20 wt % instead of 10 wt % (weight ratio or weight %).

### [Example 3] Preparation of W—Al Oxide Catalyst

5 wt % of tungsten oxide was added to 20 g of hydrogen peroxide and heated to dissolve completely. 100 g of water-boehmite was added to a solution containing 500 g of distilled water and 10 g of nitric acid, completely dissolved, and mixed with the tungsten solution. The mixed solution was neutralized to pH 8 with aqueous ammonia. After filtration, the mixture was dried at 110° C. for 6 hours and calcined at 750° C. for 4 hours to prepare W—Al oxide.

### [Example 4] Preparation of W—Al Oxide Catalyst

W—Al oxide was prepared in the same manner as in Example 3 except that the amount of tungsten oxide was 10 wt % instead of 5 wt % (weight ratio or weight %).

### [Example 5] Preparation of Ni—W—Al Oxide Catalyst

5 wt % (weight ratio) of tungsten oxide was added to 20 g of hydrogen peroxide and heated to dissolve completely. 20 wt % nickel oxide was added to distilled water to dissolve completely and mixed with the tungsten solution. 100 g of water-boehmite was completely dissolved in 500 g of distilled water and nitric acid, mixed with the tungsten-nickel solution and stirred for 6 hours and neutralized to pH 8 with ammonia water. After filtration, the mixture was dried at 110° C. for 6 hours and calcined at 750° C. for 4 hours to prepare Ni—W—Al oxide.

### [Comparative Example 1] Preparation of Al Oxide Catalyst

100 g of water-boehmite was added to 500 g of distilled water, and then 10 g of nitric acid was added and completely dissolved. The mixed solution was neutralized to pH 8 with ammonia water. After filtration, the resultant mixture was dried at 110° C. for 6 hours and calcined at 750° C. for 4 hours to prepare Al oxide.

In relation to the removal rate of perfluorinated compound, compare the perfluorinated compound removal rate of Ni—Al oxide catalysts prepared according to the present invention with that of the Al oxide catalyst prepared as a comparative example 1.

The following experiment was carried out to compare the removal rate of the perfluorinated compound (CF₄) between above Al oxide catalysts example 1 to 5 and the Al oxide catalyst prepared by the method of Comparative Example 1.

7 ml each of the catalysts prepared in Examples 1 to 5 and Comparative Example 1 were filled in a ½ inch Inconel reaction tube, and the reaction temperature was adjusted to 750 to 800° C. using an external heater, and tetrafluoromethane was decomposed while supplying 5000 ppm tetrafluoromethane (CF4) and 200 ml/min of Air under the conditions of SV 1700h⁻¹. Tetrafluoromethane conversion was calculated by Equation 1 below and the reaction was analyzed using FT-IR. The results are shown in Table 1 below.

$$CF 4 conversion ( \% ) = \frac{\begin{matrix}Reactor inlet CF 4 concentration - \\ Reactor outlet CF 4 concentration\end{matrix}}{Reactor inlet CF 4 concentration} \times 100 \qquad [ Equation 1 ]$$

TABLE 1

| | Removal rate (%) | |
|---|---|---|
| Reaction Temp. (%) | 750° C. | 800° C. |
| Example 1 | 84 | 100 |
| Example 2 | 72 | 100 |
| Example 3 | 99 | 100 |
| Example 4 | 99 | 100 |
| Example 5 | 100 | 100 |
| Comparative example 1 | 67 | 100 |

As shown in Table 1, the removal rate of tetrafluoromethane of the catalyst prepared by the process according to the present invention shows 72 to 100% under 750° C. temperature conditions. On the other hand, the tetrafluoromethane removal rate of the Al oxide catalyst of the control group showed the removal rate of tetrafluoromethane of 67% under the 750° C. temperature condition.

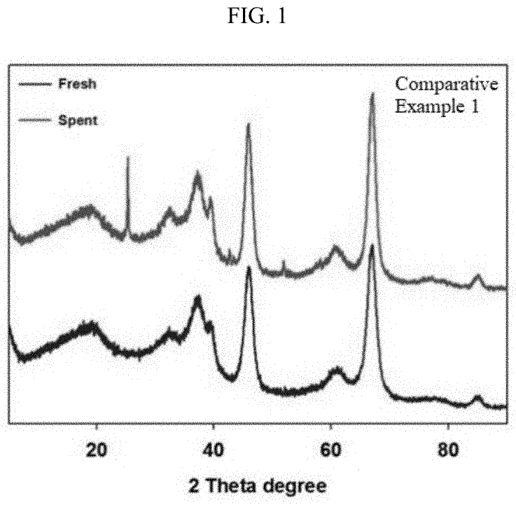

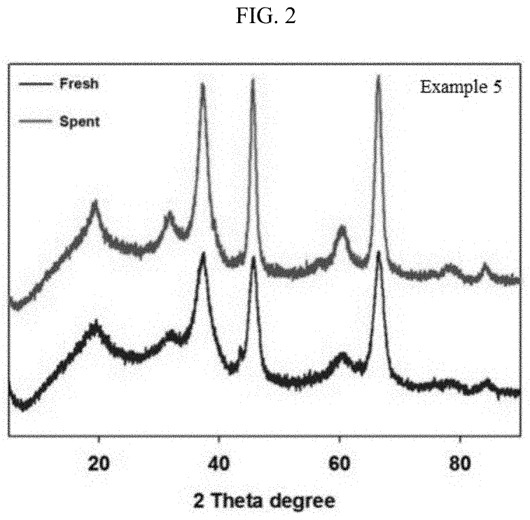

FIG. 1 shows the crystal phase change of the catalyst before and after CF₄ decomposition using the Al oxide catalyst of Comparative Example 1. FIG. 2 shows the crystal phase change of the catalyst before and after CF₄ decomposition using the Ni—W—Al oxide catalyst of Example 5 according to the present invention.

Comparing FIG. 2 with FIG. 1, it can be seen that the Ni—W—Al oxide catalyst according to the present invention maintains almost the same without any crystal phase change before and after CF₄ decomposition.

The present invention provides a supporter composed of at least one selected from alpha alumina, gamma alumina, pseudo-boehmite, and silicon and an aluminum compounds support prepared by mixing nickel (Ni) and tungsten (W) compounds in a water-containing solvent, drying, calcining and preferably provides an aluminum, tungsten and nickel compounds mixed catalyst for decomposing perfluorinated compounds in which tungsten (W) and nickel (Ni) compounds are impregnated by a neutral precipitation method as an active component. As the supporter according to the present invention efficiently removes perfluorinated compounds, it is highly applicable to industry.

What is claimed is:

1. A method for decomposing perfluorinated compounds, the method comprising:
decomposing the perfluorinated compounds using a catalyst,
wherein the catalyst comprises:
tungsten (W) compound and nickel (Ni) compound as main components; and
supporters, and
wherein the supporter is aluminum (Al) compound or silicon (Si) compound.

2. The method of claim 1, wherein:
the tungsten (W) compound is sodium tungstate (Na₂WO₄.2H₂O), ammonium paratungstate (5(NH₄)₂O.12WO₃.5H₂O), tungsten oxide (WO₃), tungsten chloride (WC₁₆) or mixtures thereof, and
the nickel (Ni) compound is nickel nitrate (Ni(NO₃)₂.6H₂O), nickel sulfate (NiSO₄.6H₂O), nickel hydroxide (Ni(OH)₂), nickel oxide (NiO) or mixtures thereof.

3. The method of claim 1, wherein the aluminum (Al) compound is alpha-alumina, gamma-alumina, or pseudo-boehmite, and the silicon (Si) compound is silica (SiO₂) or water glass.

4. The method of claim 1, wherein the catalyst is prepared from a mixture of the tungsten (W) compound, the nickel (Ni) compound and the aluminum (Al) compound by performing steps of:
mixing the tungsten (W) compound, the nickel (Ni) compound, and the aluminum (Al) compound in a water-containing solvent;
drying the mixture at a temperature of 110° C. followed by drying the mixture at a temperature of 200° C. or higher; and
calcining the mixture at a temperature of 400-1000° C.

5. The method of claim 4, wherein the mixture of the tungsten (W) compound, the nickel (Ni) compound, and the aluminum (Al) compound is prepared with a weight ratio of the Al:W:Ni compounds=100:0.1-10:0.1-50.

6. The method of claim 1, wherein the catalyst is prepared with one from a group consisting of a sol-gel (Sol-Gel) method, a neutral precipitation method, an impregnation method, and a co-precipitation method.

7. The method of claim 1, further comprising:
using neutralizers in the preparation of the catalysts for decomposing the perfluorinated compounds,
wherein the neutralizers are selected from one or more groups consisting of ammonia water, caustic soda water, and quicklime.

8. The method of claim 1, further comprising:
using dispersants for metal raw materials in the preparation of the catalysts for decomposing the perfluorinated compounds,
wherein the dispersants are selected from one or more groups consisting of sulfuric acid, hydrochloric acid, nitric acid, and acetic acid.
